(19) United States
(12) Patent Application Publication
(10) Pub. No.: US 2008/0271358 A1
(43) Pub. Date: Nov. 6, 2008

(54) SIMULATED MUDPUPPY FISHING LURE

(76) Inventor: Robert L. Meroney, Grand Saline, TX (US)

Correspondence Address: WOOD AND EISENBERG, PLLC, 6911 RICHMOND HIGHWAY, SUITE 403, Alexandria, VA, 22306, US

(21) Appl. No.: 12/168,638

(22) Filed: Jul. 7, 2008

Related U.S. Application Data
(63) Continuation-in-part of application No. 11/093,969, filed on Mar. 30, 2005.

(51) Int. Cl. A01K 85/00

(52) U.S. Cl. 43/26.2; 43/42.24; 43/42.26; 43/42.28

(57) ABSTRACT

A fishing lure is formed as a single, plastic lure body with a head, legs and a tail that are all shaped and colored to present a lifelike image of a mudpuppy. The body of the device has a hollow longitudinal chamber with its opening at the midsection of the lure. A fishing line is attached to the lure by a line connector secured to the head or a motion-creating bill. Anchoring means such as metal wire, fishing line or other strong cable-like material secures the head, bill, or line connector to a hook extending from the midsection. The lure includes an actuating mechanism, a support member having a pivot support portion, a connecting bracket connecting the support member and actuating member, a pivoting member, a pair of extending legs, and pivot extension portions which are pivotably supported by the pivot support portion.

### CONTINUITY DATA

This application is a continuation-in-part of U.S. patent application Ser. No. 11/093,969 which was filed on Mar. 30, 2005, for the inventor Robert L. Meroney.

### BACKGROUND OF THE INVENTION

1. Technical Field

This invention relates generally to fishing lures and, more particularly, to a lifelike fishing lure shaped and colored to mimic the physical characteristics of a salamander, the North American mudpuppy or waterdog (Necturus maculosu) that simulates the live swimming motion both above and below the surface of the water. Also, the lure has a longitudinal inner cavity that allows fishing line to be secured deep within the body of the lure in order to prevent a fish from escaping, even when the fish bites through the lure 10.

2. Description of Related Art

A wide-variety of live bait and artificial fishing lures are used to attract and catch fish. However, the use of live bait is not allowed in the majority of fishing competitions. Because many fishermen prefer to use live bait rather than artificial lures, some have attempted to create artificial lures that mimic the characteristics of live bait.

Artificial fishing lures shaped to resemble their live counterparts are know in the prior art. These lures resemble live bait such as worms, minnows, crawfish, and the like. Several prior art patents disclose artificial lures shaped to resemble salamanders.

For example, U.S. Pat. No. 4,993,183, issued to Carver discloses oil-impregnated flexible plastic fishing lures in various shapes including one that generally resembles a salamander.

Similarly, U.S. Design Pat. No. Des. 424,654, issued to Canales discloses a fishing lure design that also resembles a salamander. Neither of these prior art patents closely replicate the shape, coloring and swimming motion both above and below the surface of the water of a live mudpuppy.

U.S. Pat. No. 5,996,271, issued to Parker discloses a fishing lure in the general shape of a salamander. The lure has a hollow inner chamber that provides buoyancy and assists in creation of bubbles to entice fish. The thin flat portions of the legs and tail move in an oscillating motion when interacting with water also in an effort to entice fish. However, the general appearance of the device is not truly like that of a live salamander; and, the device's oscillating motion in water does not simulate a live salamander's side-to-side swimming motion.

What is needed is an artificial fishing lure that is truly a lifelike simulation of a live mudpuppy in shape, coloring, and swimming motion that is also designed to prevent a fish from escaping capture by biting through the lure.

### SUMMARY OF THE INVENTION

The present invention comprises of a single, plastic lure body with a head, legs and a tail that are all shaped and colored to present a truly lifelike image of a mudpuppy. The body of the device has a hollow longitudinal chamber with its opening at the midsection of the lure. A fishing line is attached to the lure by a line connector secured to the head or a motion-creating bill. Anchoring means such as metal wire, fishing line, or other strong cable-like material secures the head, bill, or line connector to a hook extending from the midsection.

The body of the lure replicates the physical features of a live mudpuppy and has a motion-creating bill attached to its underside. The bill works in concert with the tail to create lifelike side-to-side movement of the lure above and below the water line. On a long cast, the lure will dive two to three feet below the water line without the assistance of weights in the head or body.

The primary advantage of the fishing lure is that it replicates the physical characteristics and swimming motion of a salamander while making escape difficult for a captured fish by biting through the lure due to the anchoring means. This truly lifelike lure can be used in fishing competitions where its live counterpart cannot.

The lure includes an actuating mechanism which includes a solid state actuating member which is electrically actuated to extend and retract a predetermined distance, a support member having a pivot support portion, a connecting bracket connecting the support member and actuating member in fixed spaced relationship to each other, and a pivoting member having a top portion engageable with the actuating member, a pair of extending legs, and pivot extension portions which are pivotably supported by the pivot support portion of the support member.

### BRIEF DESCRIPTION OF THE DRAWINGS

The novel features believed characteristic of the main invention are set forth in the appended claims. The invention itself, however, as well as a preferred mode of use, further objectives, and advantages thereof, will be best understood by reference to the following detailed description of illustrative embodiments when read in conjunction with the accompanying drawings, wherein:

FIG. 1 is a top, plan view of a simulated mudpuppy fishing lure in accordance with the present invention;

FIG. 2 is side plan view of a simulated mudpuppy fishing lure in accordance with the present invention; and

FIG. 3 is a bottom plan view of a simulated mudpuppy fishing lure, in accordance with the present invention.

FIG. 4 is a bottom plan view of a simulated mudpuppy fishing lure in accordance with the present invention.

FIG. 5 is a side elevational view of an actuating mechanism for moving the legs of the lure, according to the present invention.

FIG. 6 is a side elevational view of a support member for the mechanism of FIG. 5.

FIG. 7 is a top elevational view of the mechanism of FIG. 5.

FIG. 8 is a top elevational view of the support member of FIG. 6.

FIG. 9 is a front elevational view of a pivoting member used in the mechanism of FIG. 5.

FIG. 10 is a schematic view of an electrical arrangement for powering the actuator member of FIG. 5.

FIG. 11 is a schematic view of placement of the mechanism of FIG. 5 in the fishing lures of FIGS. 1 and 4.

FIG. 12 is a schematic top elevational view of an optical power coupling to a fishing lure, to power the battery of FIG. 10 in a fishing lure.

FIG. 13 is a schematic view of a concentrator focusing light onto an end of an optic fiber usable in the device of FIG. 12.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

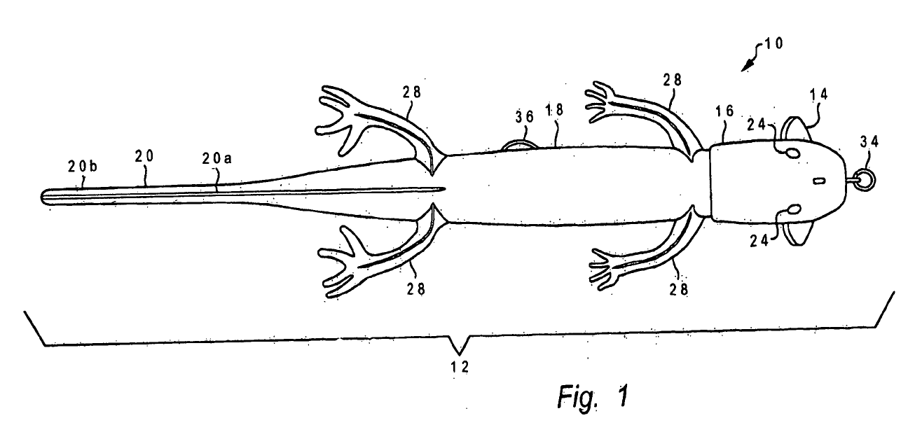

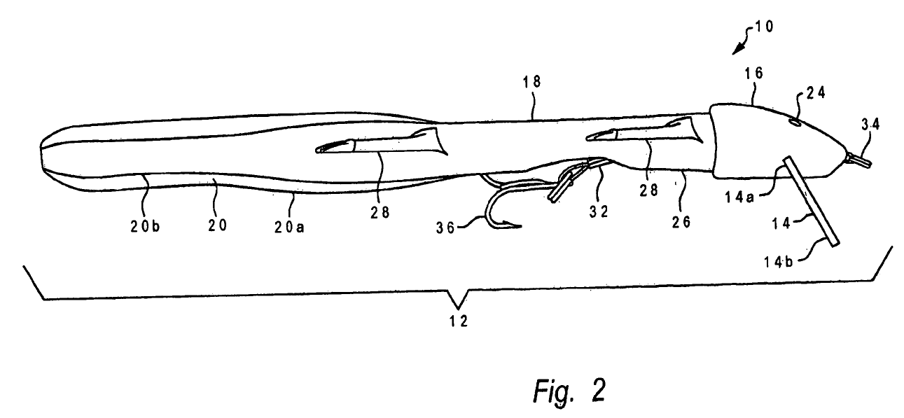

FIGS. 1 through 3 show a simulated salamander fishing lure 10, which comprises a lure body 12 and a motion-creating bill 14. The lure replicates the physical characteristics and swimming motion of a live salamander from the order Caudata. In a preferred embodiment, the lure replicates the swimming characteristics of the salamander commonly known as the mudpuppy or waterdog in the family Proteidae. The fishing lure shown FIGS. 1, 2, and 3 is in the genus Necturus.

The lure body 12 can be shaped, colored, and textured to simulate that of a salamander selected from the species Necturus lewisi, Necturus maculosus, Necturus beyeri, Necturus alabamensis, Necturus punctatus, and Proteus anguineus.

Lure body 12, shown in a top, side and bottom view in FIGS. 1, 2 and 3 respectively, comprises head 16 having a front portion and a rear portion, a midsection 18 and a tail 20. Head 16 has a pair of eyes 24 on its topside and a throat 26 on its bottom side. The first end of throat 26 is attached to the rear of head 16 and the second end of throat 26 is attached to midsection 18.

A plurality of legs 28 are attached to midsection 18. Preferably, legs 28 are attached to the front and rear portion of midsection 18 and have a plurality of toes, preferably three or four toes. Legs 28 attached to the front portion of midsection 18 extend generally outward, and rearward toward tail 20 but may extend in any direction such as towards head 16. The pair of legs 28 attached to the rear portion of midsection 18 extend generally outward, and rearward towards tail 20 and also may extend in any direction. The first end of tail 20 is attached to the rear portion of midsection 18. Tail 20 comprises, generally, of long portion 20a and distal end 20b.

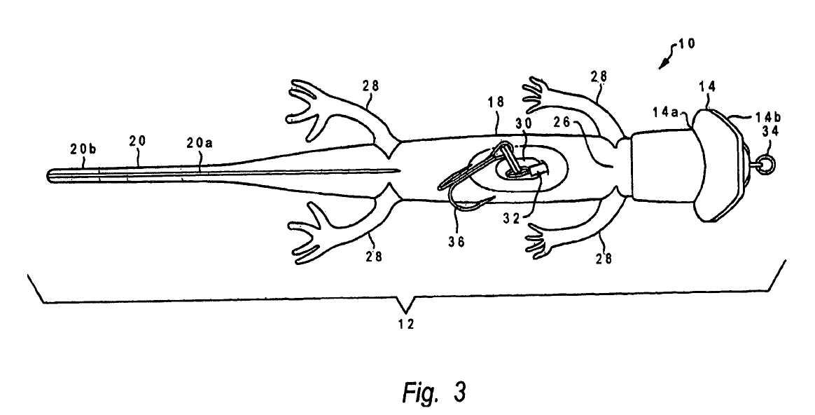

A longitudinal inner cavity 30, shown in FIG. 3, is formed within midsection 18. Inner cavity 30 contains anchoring means 32. Anchoring means 32 extends from hook 36 to line connector 34 on the front portion of head 16. Still referring to FIG. 3, the midsection 18 defines an exterior bottom side, wherein the inner cavity 30 is in direct communication with the exterior bottom side of the midsection.

The first end of motion-creating bill 14 is secured to the underside of head 16, at an angle between approximately 10-80 degrees from the front portion of head 16, and preferably approximately 40-60 degrees from front portion of head 16, to assist in producing the desired lifelike swimming effect. Motion-creating bill 14 may be located on the front or rear portion of head 16 and is preferably located in the front portion of head 16.

Bill 14 is comprised of an oblong portion 14a with a flat base at its first end and a flat oval lip 14b about its curved second end. The oblong portion 14a of bill 14 is concave with the concavity facing out away from lure body 12.

Line connector 34 can be attached to head 16 or bill 14 depending on the user's preference. Line connector 34 is used to connect and secure the fishing line to the lure. Line connector 34 is attached to anchoring means 32. Anchoring means 32 is a strong fishing line or metal wire connecting head 16, bill 14, or line connector 34 to hook 36. By using anchoring means 32, fish are not able to bite through lure 10 and escape.

Lure 10's lure body 12 and bill 14 are formed from any material flexible enough to produce a swimming effect and preferably formed from plastic materials. Lure body 12 is shaped, colored and its surface is textured to closely replicate that of a live North American mudpuppy in the family Proteidae.

Preferably, lure 10 can be produced in various sizes. However, irrespective of the size of lure 10, the following ratios are maintained: the overall length of lure body 12 to the length of head 16, midsection 18, and tail 20; the length of midsection 18 to the length of inner cavity 30; the length of head 16 to the length of bill 14; and width of bill 14's oblong portion 14a to the width of its oval lip 14b. The ratios should be maintained to ensure that the lifelike appearance and swimming motion of lure 10 is retained at any size.

When a fisherman places lure 10 in the water, he or she will first notice that lure 10 moves slightly while sitting atop of apparently still water. Then, when lure 10 is cast, it will dive up to two to three feet on a long cast without the use of any weights inside or on the lure.

Upon reeling in the fishing line, the angle of bill 14 and tail 20 work in concert to create the lifelike side-to-side swimming motion of a salamander. The concave portion of bill 14, facing the water as lure 10 is pulled through it, creates eddies that buffet lure body 12 causing the body to move 55 from side to side. Tail 20 stabilizes lure 10 by preventing lure body 12 from twisting as the side to side movement is created; thus, facilitating the lifelike swimming motion of lure 10.

If a fish is caught by using lure 10, it will find escape difficult by biting through the lure because anchoring means 32 is secured deep within lure 10's inner cavity 30. So, even if lure 10 is bitten in half, the fishing line will still be secured to the fish by hook 36 and anchoring means 32.

Therefore, with the advent of lure 10, the fisherman finally has a truly lifelike salamander lure that mimics a salamander's physical characteristics and swimming motion while preventing captured fish from easily escaping.

While the invention has been particularly shown and described with reference to a preferred embodiment, it will be understood by those skilled in the art that various changes in form and detail may be made without departing from the spirit and scope of the invention. For example, gills may be added to the lure to match the gills of a specific species.

FIG. 5 is a side elevational view of an actuating mechanism 100 for moving the legs 28 of the fishing lure 10 of FIGS. 1-4. The actuating mechanism 100 includes a support member 140, an actuating member 120, a connecting bracket 160, and a pivoting member 180 which is pivotably supported by the support member 140. In this view, the pivoting member 180 is shown in a first position designated A in the figure, and the pivoting member 180 is also shown in a second position designated B in the figure as shown in dashed outline in FIG. 5. Here, the actuating member 120 is in contact with the uppermost portion of the pivoting member 180.

The actuating member 120 is preferably a piezoelectric element, or alternatively can be an electrostrictive material. The piezoelectric element serving as the actuating member 120 is preferably a solid state actuator having relatively small dimensions, of a size which can be placed in the fishing lure 10 of FIG. 1. Such piezoelectric actuators have can have a small push and a small stroke, for example an actuator having dimensions of five sixteenth inches, by one and one quarter inches, by three and one half inches, has a push between 2.5 and 3.5 pounds and a stroke of 2 mm. For the present invention, a somewhat smaller actuator could be used having a smaller stroke and a smaller push force. Such actuators are manufactured by Dynamic Structures and Materials LLC, located in Franklin, Tenn.; the actuator described above is named High Force 2 mm PZT. Such actuators are shown, for example, in U.S. Pat. No. 7,032,287 to Spady et al., and U.S. Pat. No. 6,294,859 to Jaenker, and the entire disclosures of these patents are expressly incorporated herein by reference thereto. Other types of solid state actuators such as shape memory actuators are also known, and such other actuators are contemplated as being usable in the present invention. Fishing lure sizes for mudpuppy lures can range from 4.5 inches to 7.0 inches in length, and accordingly different sized actuators would be appropriate depending on the size being used. Manufacturing and space concerns may further limit the size of the actuator, though in any event such actuators are more space efficient than an electrical motor and therefore more serviceable in the fishing lure environment.

An advantage of use of a solid state actuator, such as the piezoelectric actuator described hereinabove, is high electrical efficiency, low power consumption, compact structure, and eliminates complexity that otherwise would be required. Such an actuator is especially useful in the fishing lure 10 of the present invention, since the material composing the fishing lure 10 is resiliently deformable and is intrinsically electrically insulating. Therefore, with the actuating mechanism 100 sealed inside the body of the fishing lure 10, proper function is assured.

The pivoting member 180 is used to actuate the legs 28 of the fishing lure 10 to wiggle or vibrate. Fish are known to detect prey not only by sight and smell, but also by sensing vibrations conducted through the water of the swimming prey. This can be considered a factor in why live bait may be more successful than fishing lures, and therefore the wiggling motion introduced by the present invention is more authentic since it is not accompanied by motor noise or the like.

FIG. 6 is a side elevational view of the support member 140 for the mechanism 100 of FIG. 5. In this view, a bore 200 is seen which passes through the support member 140. The bore 200 serves as a support which enables pivoting of the pivoting member 180.

FIG. 7 is a top elevational view of the mechanism 100 of FIG. 5. In this view, the connecting bracket 160 is seen in top elevation, as well as the actuating member 120 and the pivoting member 180.

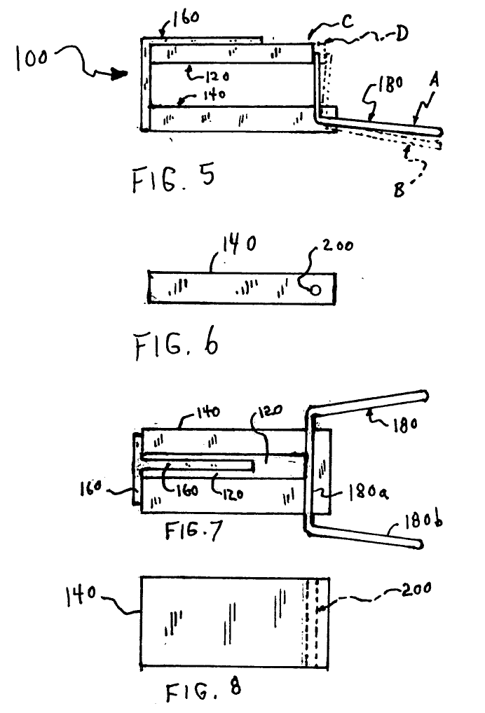

FIG. 8 is a top elevational view of the support member 140 of FIG. 6. The bore 200 is shown in dashed outline in this view.

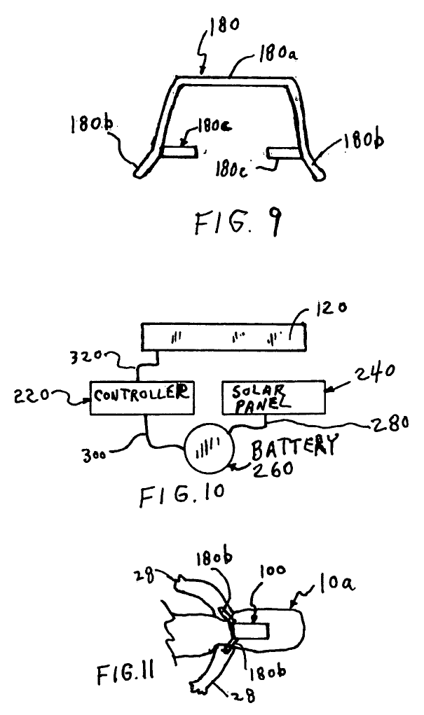

FIG. 9 is a front elevational view of the pivoting member 180 used in the mechanism of FIG. 5. In this view, the pivoting member 180 is shown as having a top portion 180a, legs 180b, and pivot extension portions 180c. The pivot extension portions 180c each engage within the bore 200 of the support member 140, so as to be pivotably supported thereby. The pivoting member 180 is preferably composed of resiliently deformable material such as a metal alloy or resilient plastic material, so as to be easily bent outwardly to permit assembly with the support member 140. The pivoting member 180 is preferably disposed in a void or open space within the fishing lure 10, with the pivot extension portions 180c extended into the material forming the legs 28 of the fishing lure 10.

FIG. 10 is a schematic view of an electrical arrangement for powering the actuating mechanism 100 of FIG. 5. In this view, a battery 260 is provided for powering the actuating mechanism 100. The battery 260 can be rechargeable, or may be a single use battery. If the battery is rechargeable, a solar panel 240 is provided for supplying power to the battery 260. The solar panel is preferably provided with illumination via a fiber optic member, but can also be powered by solar rays which pass into the interior of the fishing lure 10. Because the power requirements are extremely small, even a small amount of solar power will charge the battery sufficiently over a period of time. A controller 220 is provided to control power passing to the actuating member 120, and preferably such power is controlled as a pulsed power, so that the actuating mechanism 100 actuates the pivoting member 180 at intervals to simulate the timing of swimming motions of a mudpuppy, as discussed further below. The battery 260 is connected to the controller 220 by a connection member 300, and is connected to the solar panel 240 by a connection member 280. The controller 220 is connected to the actuating member 120 by a connection member 320. Each connection member can be a pair of insulated wires, or a coaxial cable, or any other type of electrical connection known to be usable with solar power panels.

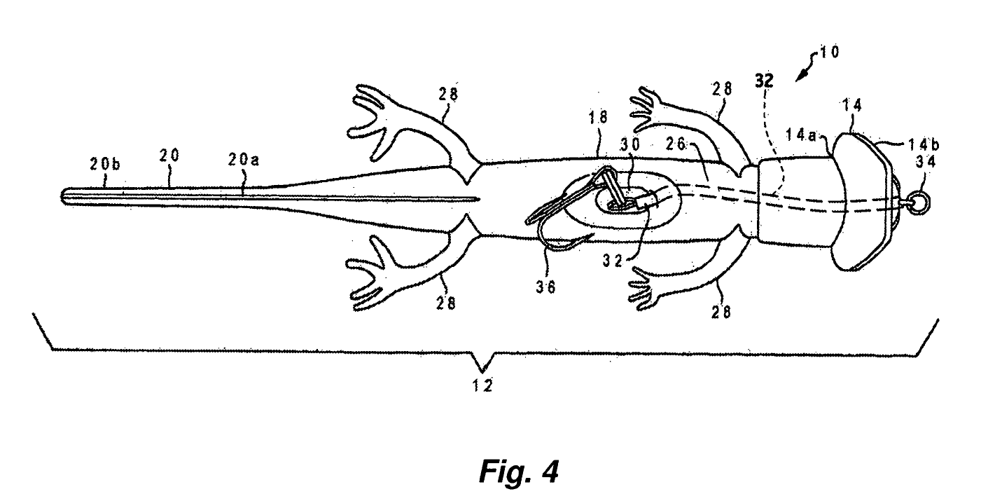

FIG. 11 is a schematic view of placement of the actuating mechanism 100 of FIG. 5 in the fishing lure 10 of FIGS. 1 and 4. Here, the actuating mechanism 100 is disposed to cause an apparent wiggling or swimming motion of the front legs 28 of the fishing lure 10. This placement is preferably anywhere convenient within the lure body, so that is does not interfere with other structures thereof. Additionally, a second actuating mechanism 100 can be disposed near the rear legs 28, to cause wiggling of those legs. The wiggling is intended to cause vibrations detectable by fish, which will alert them to the presence of potential prey and which may make the lure more attractive because it will seem more “live” to the fish.

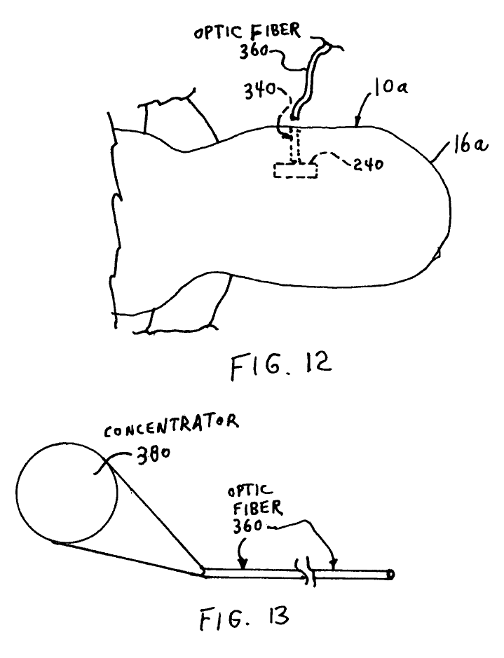

FIG. 12 is a schematic top elevational view of an optical power coupling via an optic fiber 360 to a fishing lure 10a, to power the battery 260 of FIG. 10 via the solar power panel 240 in the fishing lure 10a. In FIG. 12, the optic fiber 360 is inserted into a bore formed in the fishing lure 10a, so that it extends into the body near the solar panel 240. To preserve insulation of the solar panel, the bore does not extend all the way to it, so that the optic fiber 360 illuminates the material near the solar panel 240.

FIG. 13 is a schematic view of a concentrator 380 such as a magnifying lens which can focus light onto an end of an optic fiber 360 usable in the device of FIG. 12. Other types of concentrators can be used, including mirror and the like. The light source can be the sun, or can simply be a flashlight when charging the solar panel at night.

It is to be understood that the present invention is not limited to the sole embodiment described above, but encompasses any and all embodiments with the scope of the following claims.

1. A fishing lure that simulates a live mudpuppy's side-to-side swimming-motion, the fishing lure comprising:
a lure body, wherein said lure body is shaped, colored and textured to simulate that of a salamander from the family Proteidae, said lure body comprising a head, a midsection, two pairs of legs extending from sides of the midsection, and a tail, wherein said midsection includes an inner cavity, said inner cavity contains an anchoring means for connecting to a hook, said head defines an underside, said midsection comprises an exterior bottom side, said inner cavity is in direct communication with the exterior bottom side of said midsection;
a motion-creating bill for creating a side-to-side swimming motion, said bill is secured to said underside of said head; and
an actuating mechanism for wiggling at least one pair of legs of the fishing lure.

2. The lure in claim one, wherein said lure body is shaped, colored, and textured to simulate that of a salamander from the genus Necturus.

3. The lure in claim 1, wherein said head has a front portion and a rear portion, wherein said midsection comprises a hook and a front and rear portion, wherein the front portion of said midsection is attached to the rear portion of said head, and said tail having a first and distal end wherein the first end is attached to the rear portion of said midsection.

4. The lure in claim 3, wherein said head contains a fishing line attachment means.

5. The lure in claim 3, wherein said bill contain a fishing line attachment means.

6. The lure in claim 3, wherein said actuating mechanism comprises a piezoelectric actuating member.

7. The lure in claim 4, wherein said anchoring means extends from said midsection to said fishing line attachment means, wherein said fishing line attachment means is a line connector, wherein said line connector is located on said head.

8. The lure in claim 6, wherein said anchoring means extends from said midsection to said head of said lure. actuated to extend and retract a predetermined distance;
a support member having a pivot support portion;
a connecting bracket connecting the support member and actuating member in fixed spaced relationship to each other; and
a pivoting member having a top portion engageable with the actuating member, a pair of extending legs, and pivot extension portions which are pivotably supported by the pivot support portion of the support member.

9. The lure in claim 3, wherein said tail comprises:
a long slender portion, and
a flattened, portion at the distal end of said tail.

10. The lure in claim 1, wherein said bill comprises:
an oblong portion with a flat first end and a curved second end, and
a flat oval lip about said curved second end of said bill.

11. The lure in claim 2, wherein said head has a front portion and a rear portion, said bill is secured to said underside of said head at an angle of approximately 10-80 degrees from the front portion of said head.

12. The lure in claim 2, wherein said head has a front portion and a rear portion, said bill is secured to said underside of said head at an angle of approximately 40-60 degrees from the front portion of said head.

13. The lure of claim 1, wherein said actuating mechanism includes:
a solid state actuating member which is electrically

14. A fishing lure that simulates a live salamander's side-to-side swimming motion, the fishing lure comprising:
a lure body, wherein said lure body is shaped, colored and textured to simulate that of a salamander selected from the species Necturus lewisi, Necturus maculosus, Necturus beyeri, Necturus alabamensis, Necturus punctatus, and Proteus anguineus, said lure body comprising a head, a midsection, and a tail, wherein said midsection includes an inner cavity, said inner cavity contains an anchoring means for connecting to a hook, said midsection comprises an exterior bottom side, said inner cavity is in direct communication with the exterior bottom side of said midsection, said head defines an underside;
a motion-creating bill for creating a side-to-side swimming motion, said bill is secured to the underside of said head; and
an actuating mechanism;
wherein said actuating mechanism includes:
a solid state actuating member which is electrically actuated to extend and retract a predetermined distance;
a support member having a pivot support portion;
a connecting bracket connecting the support member and actuating member in fixed spaced relationship to each other; and
a pivoting member having a top portion engageable with the actuating member, a pair of extending legs, and pivot extension portions which are pivotably supported by the pivot support portion of the support member.

15. The lure of claim 14, further comprising a battery for powering the actuating mechanism, a controller for controlling power supplied to the actuating mechanism, and a solar panel for recharging the battery.
